(19) United States
(12) Patent Application Publication
(10) Pub. No.: US 2016/0131055 A1
(43) Pub. Date: May 12, 2016

(54) SYSTEM AND METHOD FOR DETERMINING THE REID VAPOR PRESSURE OF FUEL COMBUSTED BY AN ENGINE AND FOR CONTROLLING FUEL DELIVERY TO CYLINDERS OF THE ENGINE BASED ON THE REID VAPOR PRESSURE

(71) Applicant: GM GLOBAL TECHNOLOGY OPERATIONS LLC, Detroit, MI (US)

(72) Inventor: SCOTT JEFFREY, HARTLAND, MI (US)

(21) Appl. No.: 14/539,308

(22) Filed: Nov. 12, 2014

(51) Int. Cl. F02D 41/00; F02M 63/00; F02D 41/30; F02M 25/08

(52) U.S. Cl. CPC F02D 41/0042; F02M 25/0836; F02M 63/00; F02D 41/0045; F02D 41/3005

(57) ABSTRACT

A system according to the principles of the present disclosure includes a Reid vapor pressure (RVP) module and a fuel control module. The RVP module determines a Reid vapor pressure of fuel combusted by an engine based on a hydrocarbon concentration measured by a hydrocarbon sensor disposed in a fuel system of the engine. The fuel control module controls at least one of a fuel injector of the engine, a purge valve in an evaporative emissions (EVAP) system of the engine, and a vent valve in the EVAP system of the engine to adjust an amount of fuel delivered to cylinders of the engine based on the Reid vapor pressure.

### CROSS-REFERENCE TO RELATED APPLICATIONS

This application is related to U.S. patent application Ser. No. ______ (HDP Ref. No. 8540P-001450), which is filed on the same day as this application and claims the benefit of U.S. Provisional Application No. 62/043,741 filed on Aug. 29, 2014; and Ser. No. ______ (HDP Ref. No. 8540P-001466) filed on the same day as this application and claims the benefit of U.S. Provisional Application No. 62/043,724 filed on Aug. 29, 2014. The entire disclosure of the above applications are incorporated herein by reference.

### FIELD

The present disclosure relates to systems and methods for determining the Reid vapor pressure of fuel combusted by an engine and for controlling fuel delivery to cylinders of the engine based on the Reid vapor pressure.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

### SUMMARY

A system according to the principles of the present disclosure includes a Reid vapor pressure (RVP) module and a fuel control module. The RVP module determines a Reid vapor pressure of fuel combusted by an engine based on a hydrocarbon concentration measured by a hydrocarbon sensor disposed in a fuel system of the engine. The fuel control module controls at least one of a fuel injector of the engine, a purge valve in an evaporative emissions (EVAP) system of the engine, and a vent valve in the EVAP system of the engine to adjust an amount of fuel delivered to cylinders of the engine based on the Reid vapor pressure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example control system according to the principles of the present disclosure; and

FIG. 3 is a flowchart illustrating an example control method according to the principles of the present disclosure.

In the drawings, reference numbers may be reused to identify similar and/or identical elements.

### DETAILED DESCRIPTION

Engine controls systems typically control the amount of fuel delivered to cylinders of an engine to achieve a desired air/fuel ratio. The desired air/fuel ratio may be determined based on engine operating conditions using one or more lookup tables, which may be developed through calibration. An air/fuel ratio that is too rich or too lean may cause long engine crank periods, engine stalls, engine stumbles, rough engine idles, and spark plug fouling. Whether an air/fuel ratio causes these adverse effects depends on factors such as the volatility of the fuel that is combusted by the engine, the altitude of a vehicle, and ambient temperature. These factors may not be measured. Thus, the desired air/fuel ratio may be determined based on worst-case values for these factors such as a low fuel volatility, a high altitude, and a cold ambient temperature.

In certain engine operating conditions, the worst-case values for the fuel volatility, the altitude, and the ambient temperature may result in an air-fuel ratio that is too rich or too lean. For example, the air-fuel ratio may be too rich if the actual fuel volatility is greater than the worst-case fuel volatility, the actual altitude is less than the worst-case altitude, and/or the actual ambient temperature is greater than the worst-case ambient temperature. In addition, an air/fuel ratio that is too rich may degrade fuel economy and increase the amount of emissions produced by an engine.

A system and method according to the present disclosure avoids the adverse effects associated with an air/fuel ratio that is too rich or too lean by determining fuel volatility, altitude, and/or ambient temperature instead of assuming worst-case values thereof. In one example, the system and method determines a Reid vapor pressure of fuel combusted by an engine. Reid vapor pressure is an indicator of fuel volatility. The system and method determines the Reid vapor pressure based on a hydrocarbon concentration measured by a hydrocarbon sensor, which may disposed in a fuel tank or an evaporative emissions system.

By determining fuel volatility, altitude, and/or ambient temperature instead of assuming worst-case values thereof, the system and method ensures that the air/fuel ratio is not too rich or too lean due to inaccuracies in the worst-case values. As a result, the system and method may improve fuel economy, decrease emissions, increase purge volumes, and avoid adverse effects such as long engine crank periods, engine stalls, engine stumbles, rough engine idles, and spark plug fouling. In addition, the system and method may reduce the amount of time required to calibrate lookup tables that are used to determine a desired air/fuel ratio based on engine operating conditions.

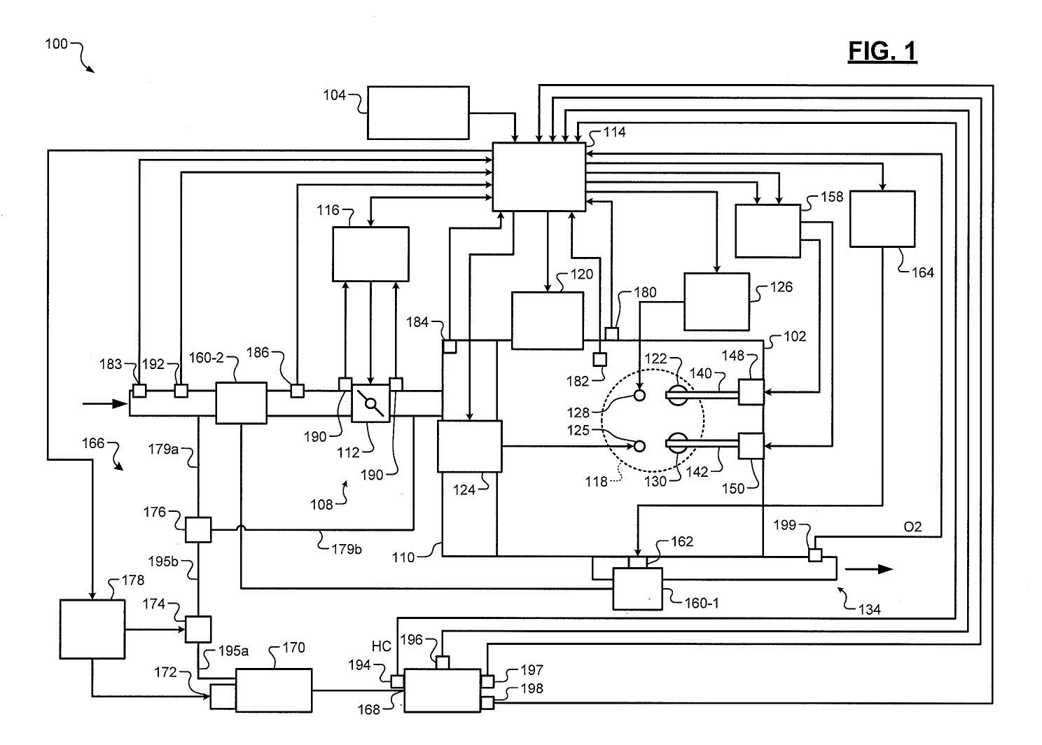

Referring to FIG. 1, an engine system 100 includes an engine 102 that combusts an air/fuel mixture to produce drive torque for a vehicle based on driver input from a driver input module 104. The driver input may be based on a position of an accelerator pedal. The driver input may also be based on a cruise control system, which may be an adaptive cruise control system that varies vehicle speed to maintain a predetermined following distance.

Air is drawn into the engine 102 through an intake system 108. The intake system 108 includes an intake manifold 110 and a throttle valve 112. For example only, the throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates a fuel injector 125 to achieve a desired air/fuel ratio. The fuel injector 125 may inject fuel directly into the cylinders, as shown in FIG. 1, or into mixing chambers associated with the cylinders. In various implementations, the fuel injector 125 may inject fuel into the intake manifold 110 at a central location or at multiple locations, such as near the intake valve 122 of each of the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, the combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The cylinder actuator module 120 may deactivate the cylinder 118 by disabling opening of the intake valve 122 and/or the exhaust valve 130. In various implementations, the intake valve 122 and/or the exhaust valve 130 may be controlled by devices other than camshafts, such as electromagnetic or electrohydraulic actuators.

The time at which the intake valve 122 is opened may be varied with respect to piston TDC by an intake cam phaser 148. The time at which the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. When implemented, variable valve lift may also be controlled by the phaser actuator module 158.

The engine system 100 may include a boost device that provides pressurized air to the intake manifold 110. For example, FIG. 1 shows a turbocharger including a hot turbine 160-1 that is powered by hot exhaust gases flowing through the exhaust system 134. The turbocharger also includes a cold air compressor 160-2, driven by the turbine 160-1, that compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed air charge, which is generated as the air is compressed. The compressed air charge may also have absorbed heat from components of the exhaust system 134. Although shown separated for purposes of illustration, the turbine 160-1 and the compressor 160-2 may be attached to each other, placing intake air in close proximity to hot exhaust.

An evaporative emissions (EVAP) system 166 collects fuel vapor from a fuel tank 168 and delivers the fuel vapor to the intake system 108 for combustion in the engine 102. The EVAP system 166 includes a canister 170, a vent valve 172, a purge valve 174, and a jet pump 176. The canister 170 adsorbs fuel from the fuel tank 168. The vent valve 172 allows atmospheric air to enter the canister 170 when the vent valve 172 is open. The purge valve 174 allows fuel vapor to flow from the canister 170 to the intake system 108 when the purge valve 174 is open. The ECM 114 controls a valve actuator module 178, which regulates the positions of the vent valve 172 and the purge valve 174. The ECM 114 may open the vent valve 172 and the purge valve 174 to purge fuel vapor from the canister 170 to the intake system 108.

Fuel vapor flows from the canister 170 to the intake system 108 through a first flow path 179a or a second flow path 179b. When the boost device is operating (e.g., when the wastegate 162 is closed), the pressure at the outlet of the first flow path 179a is less than the pressure at the outlet of the second flow path 179b. Thus, fuel vapor flows from the canister 170 to the intake system 108 through the first flow path 179a. When the boost device is not operating (e.g., when the wastegate 162 is open), the pressure at the outlet of the first flow path 179a is greater than the pressure at the outlet of the second flow path 179b. Thus, fuel vapor flows from the canister 170 to the intake system 108 through the second flow path 179b. In this regard, the first flow path 179a may be referred to as the boosted path, and the second flow path 179b may be referred to as the non-boosted path.

When the boost device is operating, the pressure of intake air upstream from the compressor 160-2 is less than the pressure of intake air downstream from the compressor 160-2. The jet pump 176 utilizes this pressure difference to create a vacuum that draws fuel vapor from the canister 170 into the intake system 108. The fuel vapor flows through the jet pump 176 and enters the intake system 108 upstream from the compressor 160-2.

In various implementations, the EVAP system 166 may include a single flow path extending from the canister 170 to the intake system 108 at a location downstream from the throttle valve 112. In these implementations, the first flow path 179a and the components disposed therein may be omitted. In turn, the second flow path 179b may be the only path for fuel vapor to flow from the canister 170 to the intake system 108.

The engine system 100 may measure the position of the crankshaft using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure of ambient air being drawn into the engine 102 may be measured using an ambient air pressure (AAP) sensor 183. The pressure within the intake manifold 110 may be measured using a manifold absolute pressure (MAP) sensor 184. In various implementations, engine vacuum, which is the difference between the ambient air pressure and the intake manifold pressure, may be measured.

The mass flow rate of air flowing into the intake manifold 110 may be measured using a mass air flow (MAF) sensor 186. In various implementations, the MAF sensor 186 may be located in a housing that also includes the throttle valve 112. The throttle actuator module 116 may monitor the position of the throttle valve 112 using one or more throttle position sensors (TPS) 190. The temperature of ambient air being drawn into the engine 102 may be measured using an intake air temperature (IAT) sensor 192.

The concentration of hydrocarbons in air flowing through the purge valve 174 may be measured using a hydrocarbon (HC) sensor 194. The HC sensor 194 may be located in the fuel tank 168 as shown. Alternatively, the HC sensor 194 may be located within the EVAP system 166. For example, the HC sensor 194 may be located in the canister 170, in a line 195a between the canister 170 and the purge valve 174, in the purge valve 174, in a line 195b between the purge valve 174 and the jet pump 176, or in the flow paths 179a or 179b. The fuel tank 168 and the EVAP system 166 may be part of a fuel system of the engine 102.

The pressure within the fuel tank 168 may be measured using a fuel tank pressure (FTP) sensor 196. The temperature within the fuel tank 168 may be measured using a fuel tank temperature (FTT) sensor 197. The composition of fuel within the fuel tank 168 may be measured using a fuel composition (FC) sensor 198. For example, the FC sensor 198 may detect the percentage of an oxygenated fuel, such as ethanol, within the fuel.

The concentration of oxygen in exhaust gas flowing through the exhaust system 134 may be measured using an oxygen (O2) sensor 199. The O2 sensor 199 may be located in the exhaust system 134 upstream from a catalytic converter (not shown). The ECM 114 uses signals from the sensors to make control decisions for the engine system 100. For example, the ECM 114 determines the Reid vapor pressure of fuel combusted by the engine 102 based on the hydrocarbon concentration from the HC sensor 194 and controls fuel delivery to cylinders of the engine 102 based on the Reid vapor pressure.

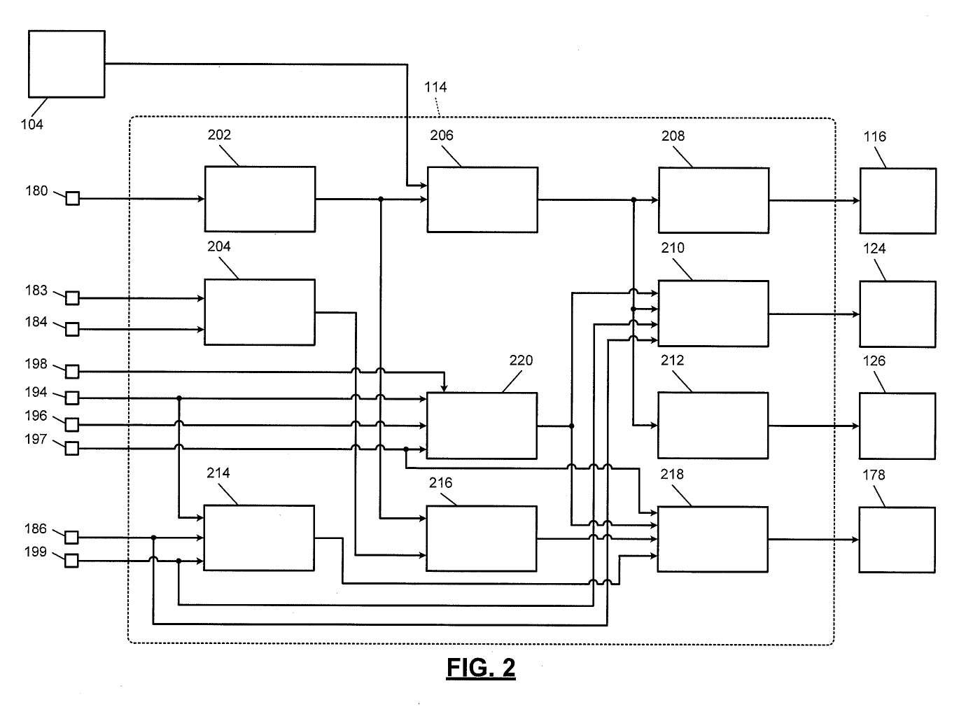

Referring now to FIG. 2, an example implementation of the ECM 114 includes an engine speed module 202, an engine vacuum module 204, and a torque request module 206. The engine speed module 202 determines engine speed. The engine speed module 202 may determine the engine speed based on the crankshaft position from the CKP sensor 180. For example, the engine speed module 202 may calculate the engine speed based on a period that elapses as the crankshaft completes one or more revolutions. The engine speed module 202 outputs the engine speed.

The engine vacuum module 204 determines engine vacuum. The engine vacuum module 204 may determine engine vacuum based on the atmospheric pressure from the AAP sensor 183 and the manifold pressure from the MAP sensor 184. The difference between the atmospheric pressure and the manifold pressure may be referred to as engine vacuum when the manifold pressure is less than the atmospheric pressure. The difference between the manifold pressure and the atmospheric pressure may be referred to as boost when the manifold pressure is greater than the atmospheric pressure. The engine vacuum module 204 outputs the engine vacuum (or boost).

The torque request module 206 determines a torque request based on the driver input from the driver input module 104. For example, the torque request module 206 may store one or more mappings of accelerator pedal position to desired torque and determine the torque request based on a selected one of the mappings. The torque request module 206 may select one of the mappings based on the engine speed and/or vehicle speed. The torque request module 206 outputs the torque request.

A throttle control module 208 controls the throttle valve 112 by instructing the throttle actuator module 116 to achieve a desired throttle area. A fuel control module 210 controls the fuel injector 125 by instructing the fuel actuator module 124 to achieve a desired injection amount and/or desired injection timing. A spark control module 212 controls the spark plug 128 by instructing the spark actuator module 126 to achieve desired spark timing.

The fuel control module 210 may adjust the desired injection amount and/or the desired injection timing to achieve a desired air/fuel ratio such as a stoichiometric air/fuel ratio. For example, the fuel control module 210 may adjust the desired injection amount and/or the desired injection timing to minimize a difference between an actual air/fuel ratio and the desired air/fuel ratio. The fuel control module 210 may determine the actual air/fuel ratio based on the oxygen level from the O2 sensor 199. Controlling the air/fuel ratio in this way may be referred to as closed-loop control of the air/fuel ratio.

The oxygen level measured by the O2 sensor 199 may not be accurate when the temperature of the O2 sensor 199 is less than an activation temperature, such as when the engine 102 is initially started after then engine 102 has been shutdown for a period. Thus, the fuel control module 210 may adjust the desired injection amount and/or the desired injection timing independent of the oxygen level measured by the O2 sensor 199. For example, the fuel control module 210 may adjust the desired injection amount and/or the desired injection timing based on the mass flow rate of intake air from the MAF sensor 186 in order to achieve the desired air/fuel ratio. Controlling the air/fuel ratio in this way may be referred to as open-loop control of the air/fuel ratio.

The throttle control module 208 and the spark control module 212 may adjust the desired throttle area and the desired spark timing, respectively, based on the torque request from the torque request module 206. For example, the throttle control module 208 may increase or decrease the desired throttle area when the torque request increases or decreases, respectively. In another example, the spark control module 212 may advance or retard the spark timing when the torque request increases or decreases, respectively.

A purge fraction module 214 determines a first purge fraction based on the hydrocarbon concentration from the HC sensor 194 and the mass flow rate of intake air from the MAF sensor 186. The purge fraction module 214 determines a second purge fraction based on the oxygen concentration from the O2 sensor 199 and the mass flow rate of intake air. The purge fraction module 214 may determine the first and second purge fractions when the purge valve 174 is open. For example, the purge fraction module 214 may determine the first and second purge fractions within a predetermined period (e.g., 1 minute to 8 minutes) after the purge valve 174 is opened.

A desired purge flow module 216 determines a desired purge flow. The desired purge flow module 216 may determine the desired purge flow based on the engine vacuum and/or the engine speed. The desired purge flow module 216 outputs the desired purge flow.

A valve control module 218 outputs a signal to the valve actuator module 178 to control the positions of the vent valve 172 and the purge valve 174. Since purge vapor includes fuel vapor, the valve control module 218 may be referred to as a fuel control module. The valve control module 218 may adjust the valve positions to minimize a difference between the desired purge flow and an actual purge flow. The valve control module 218 may determine the actual purge flow based on the first purge fraction, the second purge fraction, and/or parameters that affect flow through the purge valve 174. These factors may include a pressure drop across the purge valve 174, the fuel tank temperature from the FTP sensor 196, and/or the voltage supplied to the purge valve 174.

A Reid vapor pressure (RVP) module 220 determines a Reid vapor pressure of fuel combusted by the engine based on the hydrocarbon concentration from the HC sensor 194. For example, the RVP module 220 may determine the Reid vapor pressure based on a relationship such as

RVP=P/(A*T*ê(−B/T)) (1)

where RVP is the Reid vapor pressure, P is the vapor pressure of hydrocarbon fuel combusted by the engine 102, T is the fuel tank temperature from the FTT sensor 197, and A and B are mathematical constants. The RVP module 220 outputs the Reid vapor pressure.

The RVP module 220 may determine the hydrocarbon fuel vapor pressure based on the fuel tank pressure from the FTP sensor 196 and the hydrocarbon concentration from the HC sensor 194. For example, the RVP module 220 may determine a percentage of hydrocarbon in fuel combusted by the engine 102 based on the hydrocarbon concentration. The RVP module 220 may then multiply the fuel tank pressure by the hydrocarbon percentage to obtain the hydrocarbon fuel vapor pressure.

The values of the mathematical constants A and B may depend on the type of fuel combusted by the engine 102. For example, if the fuel tank temperature is expressed in degrees Kelvin and the hydrocarbon fuel vapor pressure is expressed in pounds per square inch, the mathematical constants A and B may be 25.61 and 2789.78, respectively, for hydrocarbon fuel. The mathematical constants A and B may have different values for oxygenated fuels such as fuels containing ethanol. The mathematical constants A and B may be predetermined based on a typical type of fuel offered in a geographical region. Alternatively, the RVP module 220 may determine the mathematical constants A and B based on the fuel composition from the FC sensor 198.

The RVP module 220 may determine the Reid vapor pressure when the engine 102 is initially started after the engine has been shutdown for a predetermined period. The RVP module 220 may determine the Reid vapor pressure when the fuel tank 168 is refilled with fuel. The RVP module 220 may determine when the fuel tank 168 is refilled with fuel based on a fuel level from a fuel level sensor disposed in the fuel tank 168.

The RVP module 220 may wait for the air/fuel mixture in the fuel tank 168 to stabilize before determining the Reid vapor pressure. For example, the RVP module 220 may not determine the Reid vapor pressure until a rate of change in the fuel tank pressure and/or the fuel tank temperature is less than a predetermined rate. The RVP module 220 may determine the Reid vapor pressure when the vehicle is stopped and/or when the vehicle is moving.

The fuel control module 210 and the valve control module 218 may adjust the amount of fuel injected into the engine 102 and the amount of purge vapor delivered to the intake system 108, respectively, based on the Reid vapor pressure. For example, the fuel control module 210 may inject a greater amount of fuel and the valve control module 218 may deliver a greater amount of purge vapor when the Reid vapor pressure is low relative to when the Reid vapor pressure is high. In addition, the fuel control module 210 may determine the desired air/fuel ratio based on engine operating conditions using one or more lookup tables, and the fuel control module 210 may select the lookup tables used based on the Reid vapor pressure. For example, the fuel control module 210 may select a lookup table having greater values for the desired air/fuel ratio when the Reid vapor pressure is low relative to when the Reid vapor pressure is high.

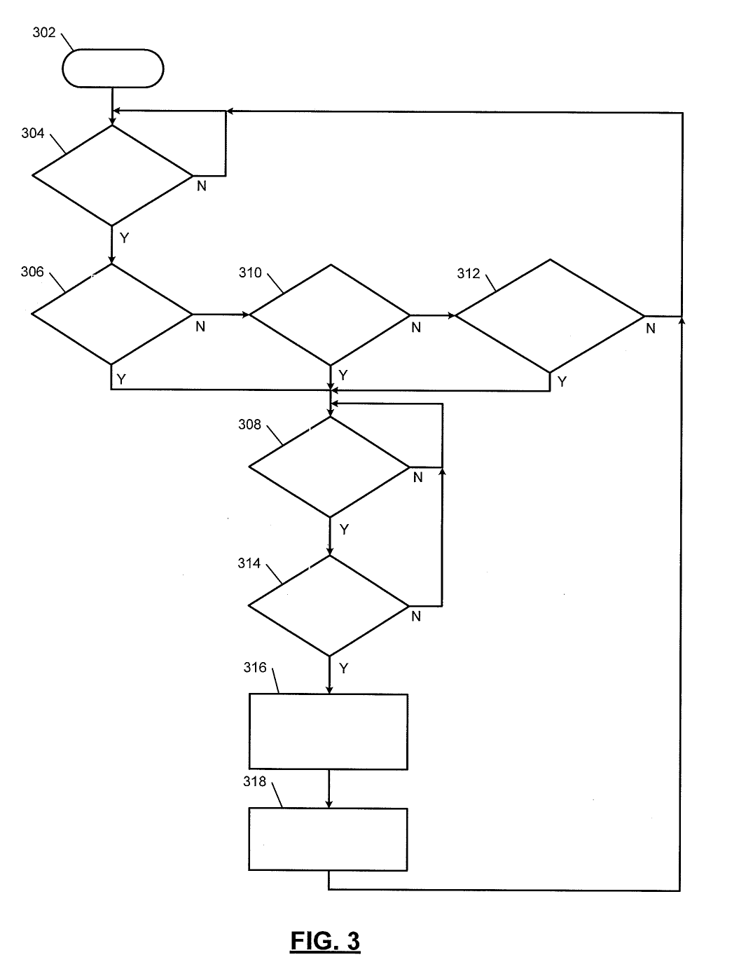

Referring now to FIG. 3, a method for determining the Reid vapor pressure of fuel combusted by an engine and for controlling fuel delivery to cylinders of the engine based on the Reid vapor pressure begins at 302. The method is described in the context of the modules included in the example implementation of the ECM 114 shown in FIG. 2 to further describe the functions performed by those modules. However, the particular modules that perform the steps of the method may be different than the description below and/or the method may be implemented apart from the modules of FIG. 2. For example, the method may be implemented by one module or more than two modules.

At 304, the RVP module 220 determines whether the engine 102 has been started recently. For example, the method may determine whether a period since the last engine start is less than a predetermined period. If the engine 102 has been started recently, the method continues at 306. Otherwise, the method remains at 304.

At 306, the RVP module 220 determines whether the engine 102 was shutdown for at least a predetermined period before the engine 102 was started. If the engine 102 was shutdown for at least a predetermined period before the engine 102 was started, the method continues at 308. Otherwise, the method continues at 310.

At 310, the RVP module 220 determines whether the fuel tank 168 has been refilled with fuel while the engine 102 was shutdown. If the fuel tank 168 has been refilled with fuel while the engine 102 was shutdown, the method continues at 308. Otherwise, the method continues at 312.

At 312, the RVP module 220 determines whether a period that has elapsed since the last Reid vapor pressure determination is greater than a predetermined period. If the elapsed period is greater than the predetermined period, the method continues at 308. Otherwise, method continues at 304.

At 308, the RVP module 220 determines whether the rate of change in the fuel tank pressure is less than a first predetermined rate. If the rate of change in the fuel tank pressure is less than the first predetermined rate, the method continues at 314. Otherwise, the method remains at 308.

At 314, the RVP module 220 determines whether the rate of change in the fuel tank temperature is less than a second predetermined rate. If the rate of change in the fuel tank temperature is less than the second predetermined rate, the method continues at 316. Otherwise, method continues at 308.

At 316, the RVP module 220 determines the Reid vapor pressure of fuel combusted by the engine 102 based on the HC concentration measured by the HC sensor 194. For example, the RVP module 220 may determine the Reid vapor pressure using relationship (1) as discussed above with respect to FIG. 2. At 318, the fuel control module 210 and the valve control module 218 control fuel injection in the engine 102 and purge vapor delivery to the engine 102 based on the Reid vapor pressure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
a Reid vapor pressure (RVP) module that determines a Reid vapor pressure of fuel combusted by an engine based on a hydrocarbon concentration measured by a hydrocarbon sensor disposed in a fuel system of the engine; and
a fuel control module that controls at least one of a fuel injector of the engine, a purge valve in an evaporative emissions (EVAP) system of the engine, and a vent valve in the EVAP system of the engine to adjust an amount of fuel delivered to cylinders of the engine based on the Reid vapor pressure.

2. The system of claim 1 wherein the RVP module determines the Reid vapor pressure further based on a pressure within a fuel tank in the fuel system, a temperature in the fuel tank, and a mathematical constant.

3. The system of claim 2 wherein the RVP module determines the mathematical constant based on a percentage of oxygenated fuel in the fuel that is combusted by the engine.

4. The system of claim 2 wherein the RVP module:
determines a vapor pressure of hydrocarbon fuel that is combusted by the engine based on the hydrocarbon concentration and the fuel tank pressure; and
determines the Reid vapor pressure based on the hydrocarbon vapor pressure.

5. The system of claim 4 wherein the RVP module determines the hydrocarbon fuel vapor pressure based on a product of the fuel tank pressure and a percentage that corresponds to the hydrocarbon concentration.

6. The system of claim 2 wherein the RVP module determines the Reid vapor pressure when a rate of change in at least one of the fuel tank pressure and the fuel tank temperature is less than a predetermined rate.

7. The system of claim 2 wherein the RVP module determines the Reid vapor pressure when the engine is started after the engine is shutdown for at least a predetermined period.

8. The system of claim 2 wherein the RVP module determines the Reid vapor pressure when the fuel tank is refilled with fuel.

9. The system of claim 1 wherein the fuel control module controls the fuel injector to adjust an amount of liquid fuel delivered to the cylinders of the engine based on the Reid vapor pressure.

10. The system of claim 1 wherein the fuel control module controls at least one of the purge valve and the vent valve to adjust an amount of purge vapor delivered to the cylinders of the engine based on the Reid vapor pressure.

11. A method comprising:
determining a Reid vapor pressure of fuel combusted by an engine based on a hydrocarbon concentration measured by a hydrocarbon sensor disposed in a fuel system of the engine; and
controlling at least one of a fuel injector of the engine, a purge valve in an evaporative emissions (EVAP) system of the engine, and a vent valve in the EVAP system of the engine to adjust an amount of fuel delivered to cylinders of the engine based on the Reid vapor pressure.

12. The method of claim 11 further comprising determining the Reid vapor pressure further based on a pressure within a fuel tank in the fuel system, a temperature in the fuel tank, and a mathematical constant.

13. The method of claim 12 further comprising determining the mathematical constant based on a percentage of oxygenated fuel in the fuel that is combusted by the engine.

14. The method of claim 12 further comprising:
determining a vapor pressure of hydrocarbon fuel that is combusted by the engine based on the hydrocarbon concentration and the fuel tank pressure; and
determining the Reid vapor pressure based on the hydrocarbon vapor pressure.

15. The method of claim 14 further comprising determining the hydrocarbon fuel vapor pressure based on a product of the fuel tank pressure and a percentage that corresponds to the hydrocarbon concentration.

16. The method of claim 12 further comprising determining the Reid vapor pressure when a rate of change in at least one of the fuel tank pressure and the fuel tank temperature is less than a predetermined rate.

17. The method of claim 12 further comprising determining the Reid vapor pressure when the engine is started after the engine is shutdown for at least a predetermined period.

18. The method of claim 12 further comprising determining the Reid vapor pressure when the fuel tank is refilled with fuel.

19. The method of claim 11 further comprising controlling the fuel injector to adjust an amount of liquid fuel delivered to the cylinders of the engine based on the Reid vapor pressure.

20. The method of claim 11 further comprising controlling at least one of the purge valve and the vent valve to adjust an amount of purge vapor delivered to the cylinders of the engine based on the Reid vapor pressure.
